(19) United States
(12) Patent Application Publication
(10) Pub. No.: US 2008/0190530 A1
(43) Pub. Date: Aug. 14, 2008

(54) Tire of Automotive Toy Car

(76) Inventor: Hai Ching Shih, Luzhou (TW)

Correspondence Address: HDSL, 4331 STEVENS BATTLE LANE, FAIRFAX, VA, 22033, US

(21) Appl. No.: 11/675,075

(22) Filed: Feb. 14, 2007

(51) Int. Cl. B60C 9/00

(52) U.S. Cl. 152/165

(57) ABSTRACT

A type of an automotive toy car has a high capacity of griping the ground and anti-tension, which improves the stability and the automotive efficiency thereof at the start moment. The tire includes a tire body nested on the tire rim, and an anti-tension netting body disposed relative to the tire body. The anti-tension netting body is made of anti-tension material. With these configurations, the anti-tension capability of the tire body is improved, which is not liable to distort in the period of forepart accelerate. Then the toy car is prevented from turning over for the reason of distorting of the tire body. In addition, the stability and the automotive efficiency of the toy car at the start moment are also improved.

### BACKGROUND

The present invention relates to a tire of automotive toy cars, and more particularly to a tire having a high capacity of griping the ground and anti-tension, which improves the stability and the automotive efficiency thereof at the start moment.

Generally, the tire of toy car can be divided into two types: the rigid tire made of elasto-plastic material and the soft tire made of rubber material. The rigid tire is not easy to distort, but has a smaller friction coefficient, then the force to grip the ground of this type of the tires is not strong enough, which is liable to skid. Therefore, the rigid tire is mainly applied to the toy cars without automotive power or with lower automotive power. On the other hand, the soft tire is mainly applied to the high-level automotive toy cars because of the capability of strongly griping the ground and providing enough buffers to avoid shaking.

Nowadays, the automotive toy car use an engine or a motor as a power source, its acceleration at the start moment is very high. As shown in FIGS. 1 and 2, the typical tire includes a tire rim 20 and a tire body 10 nested on the tire rim 20, and the tire has a speed higher than that of a general car in the period of forepart accelerate. However, the tire body 10 is made of soft rubber material, which has a bad anti-tension capability. Then the tire body 10 is elongated to an oval shape (as shown in FIG. 1), and the width of the tire body 10 is becoming narrow (as shown in FIG. 2, from a side view). The pattern of the tire body 10 is distorted, which will significantly impact the motive of the toy car. Moreover, the toy car is liable to turn over because of distorting or skidding of the tire body 10. That is, the stability and the automotive efficiency of this toy car at the start moment are significantly impacted.

Accordingly, what is needed is a tire of an automotive toy car that can overcome the above-described deficiencies.

### BRIEF SUMMARY

A tire of an automotive car is not easy to be distorted, which can improve the stability and the automotive efficiency of this toy car at the start moment.

The tire includes a tire body made of rubber material, and an anti-tension netting body disposed relative to the tire body.

The anti-tension netting body is attached to an inner surface of the tire body.

The anti-tension netting body is attached to an outer surface of the tire body, adjacent to pattern of the tire body.

The anti-tension netting body is disposed inside the tire body.

The tire body includes several layers of the anti-tension netting body therein.

The anti-tension netting body is made of non-woven cloth or steel wire, or other anti-tension material.

The tire further includes an adhesive layer attached to a surface of the anti-tension netting body, to improve the joint intensity between the tire body and the anti-tension netting body.

With these configurations, the anti-tension capability of the tire body is improved, which is not liable to distort in the period of forepart accelerate. Then the toy car is prevented from turning over for the reason of distorting of the tire body. In addition, the stability and the automotive efficiency of the toy car at the start moment are also improved.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, front view of a conventional tire of a toy car, showing the tire in a start moment or in a period of accelerating;

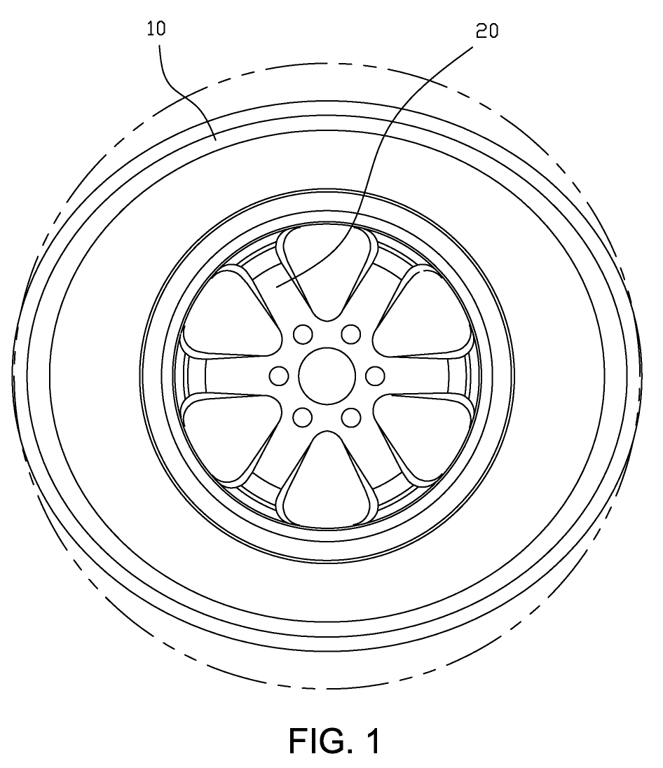

FIG. 2 is a schematic, side view of the conventional tire of FIG. 1, showing the tire in a start moment or in a period of accelerating;

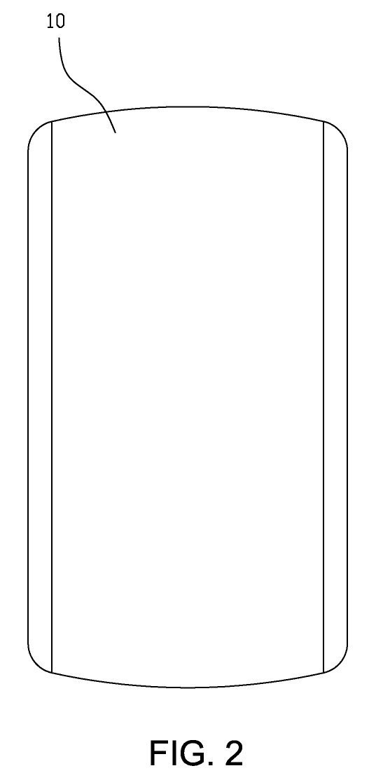

FIG. 3 is a perspective, schematic view of part of a tire according to an embodiment of the present invention, part of the tire are shown in cross-sectional view;

FIG. 4 is a side, schematic view of part of the tire of FIG. 3, part of the tire are shown in cross-sectional view;

FIG. 5 is a schematic, front view of the type of FIG. 3, showing the tire in a start moment or in a period of accelerating;

FIG. 6 is a schematic, side view of the type of FIG. 3, showing the tire in a start moment or in a period of accelerating;

FIG. 7 is a side, schematic view of part of a tire according to another embodiment of the present invention, part of the tire are shown in cross-sectional view; and

FIG. 8 is a side, schematic view of part of a tire according to further another embodiment of the present invention, part of the tire are shown in cross-sectional view.

### DETAILED DESCRIPTION

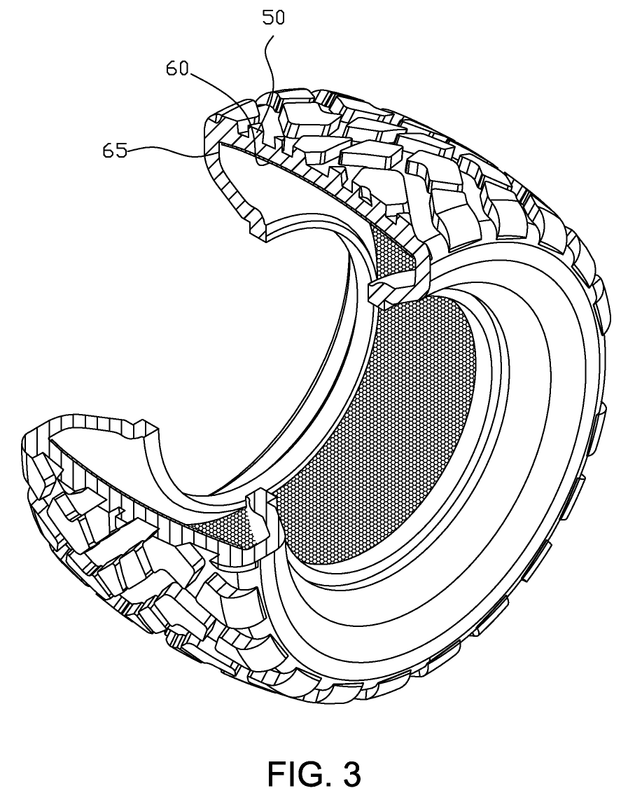

Referring to FIG. 3, a perspective, schematic view of part of a tire according to an embodiment of the present invention is shown. The tire includes a tire rim (not shown) and a tire body 50 nested on the tire rim, and the tire body 50 is made of rubber material via a molding process, which has a preferable friction to improve a force of griping the ground.

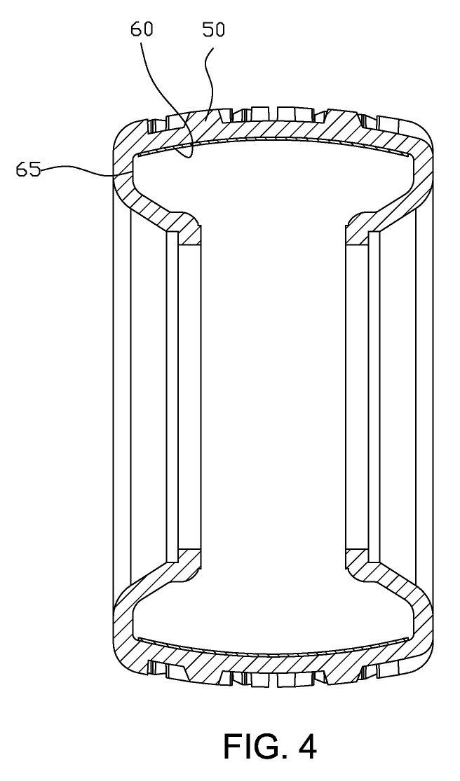

Also referring to FIG. 4, during the process of fabricating the tire body 50, an anti-tension netting body 60 is disposed in the mould of the tire body 50 firstly. The anti-tension netting body 60 can be made of carbon fiber, fiber material, non-woven cloth, steel wire, or other anti-tension materials. In this illustrated embodiment, the anti-tension netting body 60 forms a single layer shape, and is attached to an inner surface of the tire body 50. Moreover, an adhesive layer 65 is attached to a surface of the anti-tension netting body 60, to improve the joint intensity between the tire body 50 and the anti-tension netting body 60. Then, casting the melting rubber material into the mould of the tire body 50, to make the rubber material to completely surround the anti-tension netting body 60. Finally, cooling the rubber material to get a tire body 50 having a pre-determined shape.

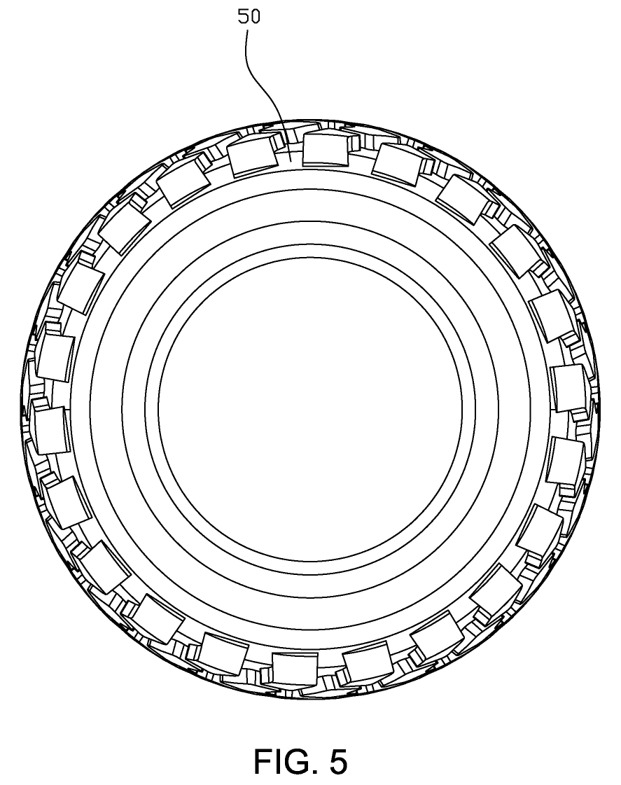

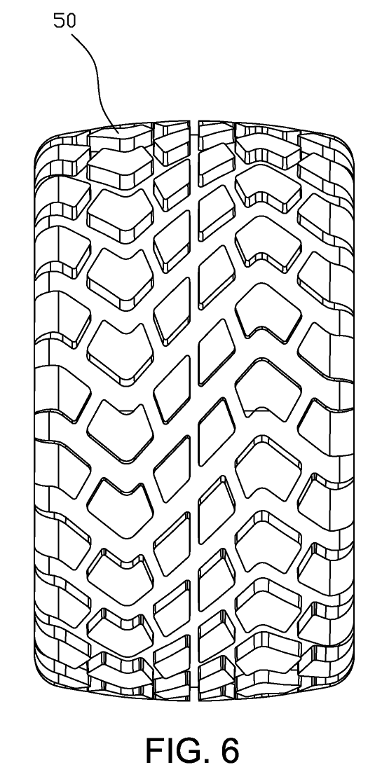

Referring to FIGS. 4-6, the tire body 50 includes the anti-tension netting body 60 therein, and then the soft tire body 50 can get a preferable anti-tension capability. Furthermore, for the reason of being made of rubber material, the tire body 50 can maintain the friction between the pattern thereof and the ground and the force of griping the ground. In addition, the anti-tension netting body 60 prevent the tire body from being distorted when the toy car equipping the tire body at the start moment or in the period of accelerating. The tire body 50 maintains the figure (as shown in FIGS. 5 and 6) can prevent the toy car from turning over or jumping, so as to improve the stability and the automotive efficiency of this toy car. The tire body 50 is made of soft material, then it can provide buffer and avoid shaking of the toy car.

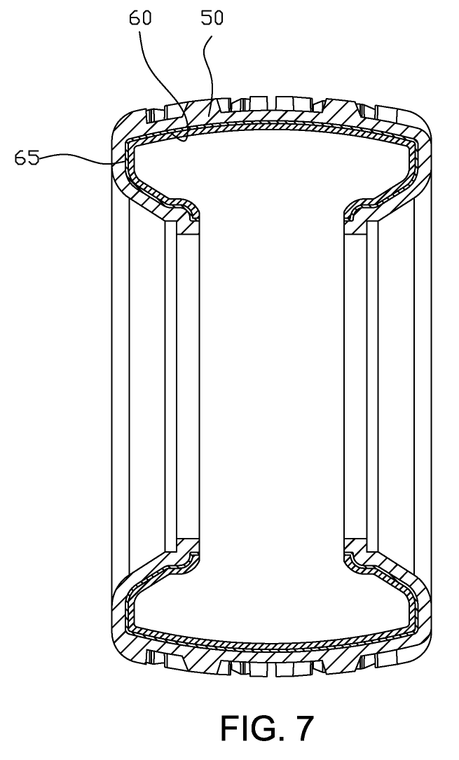

Referring to FIG. 7, a side, schematic view of part of a tire according to another embodiment of the present invention is shown. The anti-tension netting body 60 is disposed inside the tire body 50.

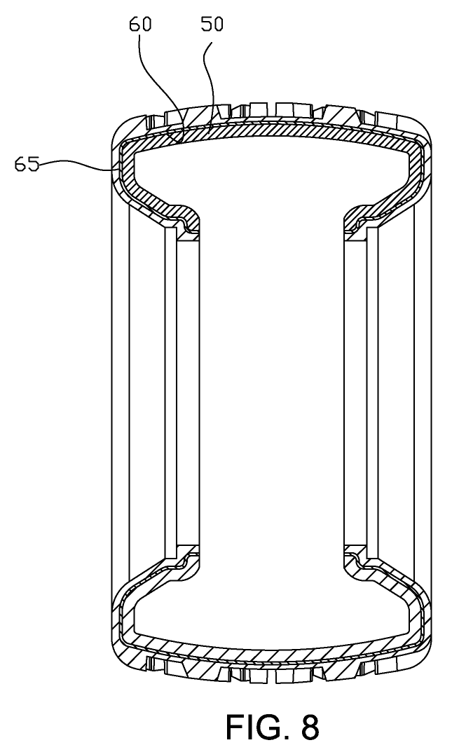

Referring to FIG. 8, a side, schematic view of part of a tire according to further another embodiment of the present invention is shown. The anti-tension netting body 60 is disposed attache to an outer surface of the tire body 50, adjacent to pattern of the tire body 50.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A tire for automotive toy car, comprising a tire body made of rubber material, and an anti-tension netting body disposed relative to the tire body.

2. The tire as claimed in claim 1, further comprising an adhesive layer attached to a surface of the anti-tension netting body, to improve a joint intensity between the tire body and the anti-tension netting body.

3. The tire as claimed in claim 1, wherein the anti-tension netting body is attached to an inner surface of the tire body.

4. The tire as claimed in claim 3, further comprising an adhesive layer attached to a surface of the anti-tension netting body, to improve a joint intensity between the tire body and the anti-tension netting body.

5. The tire as claimed in claim 1, wherein the anti-tension netting body is attached to an outer surface of the tire body, adjacent to a pattern of the tire body.

6. The tire as claimed in claim 5, further comprising an adhesive layer attached to a surface of the anti-tension netting body, to improve a joint intensity between the tire body and the anti-tension netting body.

7. The tire as claimed in claim 1, wherein the anti-tension netting body is disposed inside the tire body.

8. The tire as claimed in claim 7, further comprising an adhesive layer attached to a surface of the anti-tension netting body, to improve a joint intensity between the tire body and the anti-tension netting body.
